(19) United States
(12) Patent Application Publication
(10) Pub. No.: US 2008/0035727 A1
(43) Pub. Date: Feb. 14, 2008

(54) WELDING INVENTORY TRACKING, STORING, AND DISTRIBUTION SYSTEM

(76) Inventors: David A. Stanzel, Appleton, WI (US); Todd G. Batzler, Hortonville, WI (US); David Lu, Menasha, WI (US); Jeremy D. Overesch, Appleton, WI (US); Jon O. Reynolds, Appleton, WI (US); Mark Ulrich, New London, WI (US); Bernard J. Vogel, Troy, OH (US)

Correspondence Address: ZIOLKOWSKI PATENT SOLUTIONS GROUP, SC (ITW), 136 S WISCONSIN ST, PORT WASHINGTON, WI, 53074, US

(21) Appl. No.: 11/460,007

(22) Filed: Jul. 26, 2006

(51) Int. Cl. G06Q 30/00

(52) U.S. Cl. 235/385

(57) ABSTRACT

A system and method for tracking, storing, and distributing inventory of welding-type consumables within an industrial facility includes conveyors for moving and storing welding-type consumables on pallets or other shipment units to the proper work zones. Various sensors or detectors are employed at the loading and unloading ends of the conveyors to provide data for determining quantity, type, and/or location information for monitoring inventory or even automated reordering. Therefore, such a system and method provides robust, reliable, and inexpensive inventory management that can be adaptable and compatible with multiple brands, types, and shipment varieties of inventory materials.

### BACKGROUND OF THE INVENTION

The present invention relates generally to inventory control of welding-type consumables, and more specifically, to a system and method for storing, distributing, and tracking the quantity and location of inventory of welding consumable inventory, such as welding filler wire, within a manufacturing facility or other industrial environment.

Within many manufacturing industries, the use of large production facilities requiring substantial volumes of welding consumables at multiple locations is common. It is well-recognized that maintaining an efficient and accurate system for monitoring, storing, and distributing current welding consumable inventory already on-hand in such a facility is no simple task. Likewise, since all consumables often arrive at the same location, such as a delivery dock, keeping track of the quantity and type of incoming consumable deliveries entering a facility can become unnecessarily difficult or inefficient when an organized inventory management system is not in place. Inventory management disorganization can lead to lost, unaccounted for, or stolen deliveries of welding consumables, work stoppages, and overall facility inefficiency. Any of these results can induce manufacturers to inadvertently over- or under-order new shipments of consumables, because on-hand inventory counts will not accurately reflect the actual volume of consumables in the facility.

From the outset of any inventory process, simply moving delivered consumable shipments to the proper work locations within a large manufacturing facility can present logistical issues. Ideally, the movement of consumables from delivery docks to work zones should not only be quick and safe, but as accurate and as relatively foolproof as possible. However, a common arrangement of many manufacturing facilities can further complicate distribution. Many industrial production facilities are essentially large, open, warehouse-type spaces with various work “zones,” often designated by paint demarcation on the floor. Each zone is the area of the facility in which certain steps in the manufacturing process occur, and thus where particular welding processes take place. Within each zone, various work “cells” are often designated where these welding processes are performed. Thus, ensuring that dock personnel, who are usually not knowledgeable welding personnel and may not even be familiar with the manufacturing process of the facility in general, get the right types of welding consumables to the right work zones and cells within the facility can be difficult.

Even when welding consumables arrive at the correct work zone or welding cell destination, other inventory management issues can still reduce the overall efficiency of a manufacturing facility. The proper wire in the proper zone could still be misplaced within that zone due to storage disorganization. In expansive, often cluttered industrial environments, even whole pallets can go unnoticed. Storing consumables in disarray can also increase the amount of time it takes welding personnel to replenish the supply of consumables at their welding cells due to longer time spent locating and accessing desired consumable packages. Common practice within large manufacturing plants is to use a portion of the work zone floor as a storage area for pallets of consumables. Those skilled in the art will appreciate the difficulty in maintaining organization, and even in keeping nearby travel lanes and exits clear, when inventory is deposited in disarray.

Even if consumables are stored in some organized manner, there is no guarantee that the oldest inventory will be consumed first. Ideally, manufacturers would like welding consumables to be used in the order in which they were received. However, when inventory units are not stored in a work zone in a conducive order, older inventory is often blocked or hidden by newer inventory and does not get used first.

Storage and distribution issues aside, efficient inventory monitoring and reordering of welding consumables is achieved when manufacturers have relatively accurate figures for both the amounts of consumables on-hand and the general rate at which each type of consumable is being used. Some current inventory methods keep detailed track of usage rates, by linear foot of weld wire consumed for example, but do not keep continuous track of the amount of consumables remaining on-hand. Such methods also require that the consumables be of a particular brand or proprietary type so that accurate scanning can be done. Conversely, some known inventory methods keep track of the amount of consumables on-hand, but do not keep sufficiently detailed records to ascertain usage rates or more advanced usage statistics such as the amount of a particular consumables used historically by day, month, or time of year, or the number and type of current orders and jobs being performed at the facility.

Inventory and usage tracking is made more difficult by the fact that, for larger facilities, welding consumables are usually shipped by pallets. For example, welding filler wire pallets frequently weigh approximately 1600 to 2000 pounds, and can be comprised of individual weld wire packages of about 33, 60, or 400 pounds. Many facilities use up multiple pallets per week or even per day, sometimes totaling as much as 20,000 to 40,000 pounds of consumable wire per week. Thus, tracking usage by linear foot may be unnecessarily precise. Monitoring inventory by the number of remaining pallets, remaining packages within those pallets, the total weight of a particular consumable on-hand, and rates of usage by each of these metrics provides more usable figures for inventory maintenance.

Other known methods of tracking inventory that allow for continuous monitoring of inventory levels present disadvantages in that their cost per inventory unit is unjustified. For example, having RFID antennas and readers arranged in grids over the entirety of a production facility is unduly expensive considering the transient nature of consumable inventory. In terms of the initial capital investment in a scanning grid, the expense per RFID tag for each inventory unit, and the expenses involved in training employees how to operate and manage such a complex system, the costs of such systems outweigh the benefits. And, as the range of each RFID tag and reader is increased, their cost increases drastically; but short range RFID systems may not be sufficient for large manufacturing environments. Furthermore, while such wireless systems can provide very accurate inventory monitoring, they are often less reliable due to their complexity. Thus, the maintenance and other unforeseen problems associated with wireless monitoring may further reduce the efficiency of a facility. In addition, while such systems are very useful in tracking and locating inventory, they do not provide for organized storage or ensure that the oldest inventory is used first.

In distinction, systems which have lower per-unit costs and which don't utilize wireless tracking result in less reliable inventory monitoring. For example, inventory systems in which inventory counts are increased when consumable shipments are scanned upon arrival, and decreased when the consumables are scanned again upon usage, rely on records of inventory rather than a continuous monitoring. If an inventory unit was misplaced in the facility, such systems do not have the capability to locate the inventory, do not reflect such a loss in reordering calculations, and do not ensure that older inventory is used first. Furthermore, systems which do not provide continuous monitoring of inventory location are incapable of providing other advanced features like automatically alerting users when the wrong consumable is inadvertently delivered to the wrong work zone.

It would therefore be desirable to have a reliably and relatively low tech yet robust and organized system and method for easily and inexpensively storing, monitoring, and distributing inventory of welding consumables within a manufacturing facility or other industrial environment. It would also be desirable if such system was adaptable to varying needs of the facility and compatible with multiple brands or types of consumables. Furthermore, it is recognized that such a system or method would be additionally desirable if it were equipped to make inventory maintenance and reordering faster and simpler, or even automatic.

### BRIEF DESCRIPTION OF THE INVENTION

The present invention provides a system and method for tracking, storing, and distributing welding-type consumables within a manufacturing or other environment that overcome the aforementioned drawbacks. Conveyors or tracks for moving and storing welding-type consumable pallets or other shipment units carry the proper type or types of consumables to the right welding zones within a manufacturing or other environment. Various sensors and detectors associated with the conveyors provide data for determining accurate quantity, type, and/or location information for monitoring inventory or even automated reordering.

Therefore in accordance with one aspect of the present invention, an inventory management system is disclosed which includes a conveyor, having first and second ends, that is configured to store and move units of welding inventory to at least one work zone. A reader for determining type information of inventory units is positioned at the first end, an inventory unit sensor is arranged to detect the number of welding inventory units on the conveyor, and an inventory subunit sensor for detecting the number of subunits within an inventory unit is positioned at the second end of the conveyor. An inventory center is also included which receives data from the reader, the inventory unit sensor, and the inventory subunit sensor. The reader, the information center, or both, are programmed to determine whether each welding inventory unit loaded onto the conveyor is of a type corresponding to a welding process that is being performed in the at least one work zone.

According to another aspect of the present invention, an apparatus for maintaining welding consumable inventory includes one or more storage surfaces having loading ends configured to receive welding consumable shipment units and scan information therefrom and unloading ends configured to determine a remaining number of subunits of a welding consumable shipment unit. The loading ends are positioned in receiving areas and the unloading ends are positioned in work zones. At least one processing unit is also included, and is configured to determine whether welding consumable shipment units loaded on the one or more storage surfaces are the correct type for the work zone, to manage a queue of welding consumable shipment units on the one or more storage surfaces, and to calculate one or more inventory amounts for the shipment units.

In accordance with a further aspect of the present invention, a method for implementing an automated welding inventory system is disclosed, comprising the steps of delivering welding consumables to a welding facility in bulk shipments, monitoring type information of each bulk shipment that is loaded onto a conveyor, monitoring the quantity of each type of bulk shipment loaded onto a conveyor, maintaining a current inventory count for each type of welding consumable based on the quantity and type information, generating an order request when one or more current inventory counts reach a threshold amount, and delivering new shipments to fill the order request.

Various other features and advantages of the present invention will be made apparent from the following detailed description and the drawings.

### BRIEF DESCRIPTION OF THE DRAWINGS

The drawings illustrate some preferred embodiments presently contemplated for carrying out the invention.

In the drawings:

FIG. 1 is a schematic view of a welding inventory and distribution system in accordance with the present invention.

FIG. 2 is a perspective view of a detailed section of the welding inventory and distribution system of FIG. 1 in accordance with the present invention.

FIG. 3 is a perspective view of an alternate detailed section of the welding inventory and distribution system of FIG. 1 in accordance with the present invention.

FIG. 4 is a perspective view of yet another detailed section of the welding inventory and distribution system of FIG. 1 in accordance with the present invention.

FIG. 5 is a block diagram showing process steps of one embodiment of the present invention.

FIG. 6 is a block diagram showing process steps of one embodiment of the present invention.

FIG. 7 is a block diagram showing high level steps of one embodiment of the present invention.

### DETAILED DESCRIPTION OF THE PREFERRED EMBODIMENT

As one skilled in the art will fully appreciate, the following description of welding consumables, welding accessories, and welding systems applies equally to the constituents of other high power output systems, such as heating and cutting systems, that utilize similar consumable materials. One of ordinary skill in the art will appreciate that reference to welding wire, shielding gas, flux, welding consumables, welding-type consumables, welders, or welding generally, includes the similar or corresponding concepts and materials of welding, cutting, or heating systems. Thus, description of the consumables, accessories, and other inventory for a welding apparatus illustrates just one environment in which the present invention may be implemented.

Broadly, a preferred embodiment of the present invention relates to a system for storing and conveying inventory of welding-type consumables to welding work zones within a manufacturing facility or similar environment. The consumables are typically delivered to such a facility in bulk shipments or containers. For example, welding filler wire is generally shipped as individual packages loaded on pallets or skids. However, it is appreciated that the present invention is compatible with and/or adaptable to use with a wide variety of welding inventory shipment units and containers, such as pallets, skids, tanks, boxes, trays, bins, carts, barrels, drums, and the like. For these reasons, it is recognized that the present invention may find use in other settings where a large volume of regularly used and replenished production items or raw materials must be inventoried, tracked, stored, and/or distributed to work zones within an industrial environment.

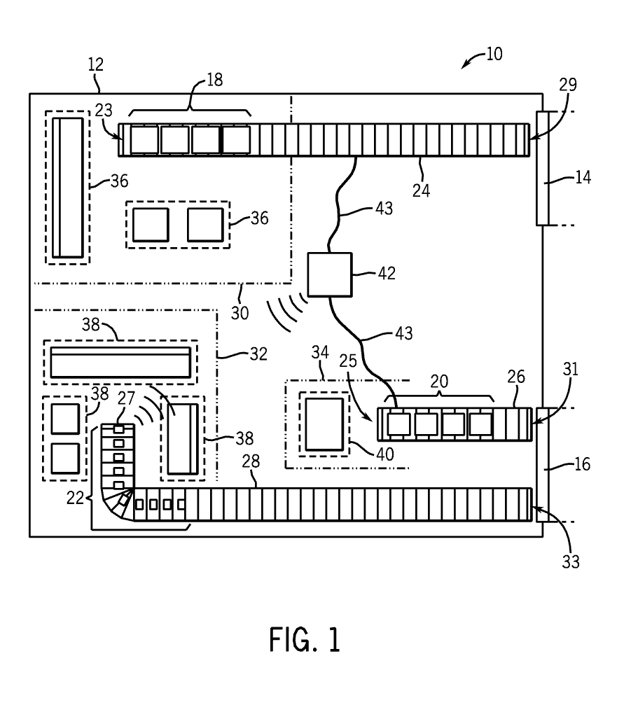

Referring now to FIG. 1, a schematic view of an inventory and distribution system 10 of the present invention implemented in a manufacturing facility 12 is shown. In facility 12, inventory is delivered from a welding-type consumable vendor at delivery docks 14 and 16. It is appreciated that a manufacturer could arrange for only one type of welding consumable 18 to be delivered to a particular dock, such as shown for dock 14, or that multiple types of inventory 20, 22 could be delivered at one dock, such as shown for dock 16. In either event, inventory 18, 20, 22 is loaded onto the proper track 24, 26, 28 to be conveyed to a work zone 30, 32, 34. Tracks 24, 26, 28 are shown as having their loading ends 29, 31, 33 located relatively near loading docks 14, 16 for ease of inventory movement. However, it is appreciated that tracks 24, 26, 28 may also extend entirely or almost entirely within a work zone 30, 32, 34 to serve primarily storage rather than conveying functions. While the specific layout of each facility in which the present invention is implemented may dictate the most efficient lengths and orientations of tracks, it will typically be beneficial for tracks to have unloading ends 23, 25, 27 disposed in or near work zones 30, 32, 34. Likewise, it will typically be beneficial for the loading ends 29, 31, 33 of tracks to be disposed either in or near receiving areas such as docks 14, 16 or oriented towards some other receiving area or inventory distribution channel in a manner to make inventory movement and loading most efficient. Arrangements of sensors, detectors, and/or readers (not shown) disposed on or near tracks 24, 26, and 28 may be employed to automatically identify and/or distinguish between the various types of inventory shipments 18, 20, 22.

Each work zone 30, 32, 34 is shown containing only welding cells 36, 38, 40 which utilize the same type of consumable. Each welding cell 36, 38, 40 is an area of the manufacturing facility 12 where a certain type of welding operation is conducted as a stage in the overall production process. Thus, each cell 36, 38, 40 may require only one type of welding consumable. A manufacturer who desires the efficiency, reliability, and lower costs per unit of relatively simple implementations can make use of the present invention in an embodiment where only one type of welding consumable, such as inventory 18, is loaded onto each conveyor, such as conveyor 24. In such a case, dock personnel will need less training, the sensors associated with the conveyors need not be as complex, and initial capital investments will be lower than the aforementioned prior art techniques. Thus, the present invention is particularly useful in facilities that use large quantities of one type of welding consumable at individual locations.

However, other implementations and arrangements of tracks 24, 26, 28 within a facility 12 are contemplated. To some extent, the size and shape of a facility, the manner of receiving inventory, and the types of welding processes being performed may dictate which type of track arrangement is most beneficial. For example, it is appreciated that certain welding processes require multiple types of consumables, such as flux, electrode tips, filler wire, or shielding gas, in which case either tracks 24, 26, 28 could be configured to convey more than one type of consumable at once or multiple tracks could convey consumables to the same work zone or welding cell. Also, it is recognized that several work zones or welding cells may all require the same welding-type consumables, in which case one track might facilitate common inventory storage for several welding processes and/or steps in a production process. In other words, one track can service or support multiple welding zones and/or one welding zone can be supported by multiple tracks. Thus, the various options, adaptations, and alternative embodiments of the present invention render it beneficial for use when multiple types of consumable are loaded onto each conveyor, when increased inventory management automation is desired, and when inventory must be conveyed to work zones in other than single file order or first-in first-out order.

In the example shown, track 24 conveys inventory 18 from delivery dock 14 to work zone 30. By organizing and storing welding-type inventory only on tracks, the practice of storing inventory containers on portions of the floor in work zones can be eliminated. In essence, the tracks 24, 26, 28 are the “storage zones” of facility 12. Welding personnel working at cells 34 replenish their supplies of consumables by removing packages or other subunits of the consumable from the inventory shipment units 18 located on track 24. Preferably, inventory 18 is conveyed in a single-file order along track 24 so that only inventory packages from the shipment unit at the unloading end 23 are being used by welding personnel at any given time. In this manner, a first-in first-out inventory order is maintained. Track 28 operates in a similar manner, conveying inventory 22 from dock 16 to work zone 32 for use by welding cells 38. A welding zone 34 may contain one welding cell 40 that requires enough consumable inventory 20 to warrant its own track 26.

Tracks 24 and 26 are equipped with data wires 43 to transmit information from the sensors and detectors (not shown) associated therewith to an information center 42. It is understood, however, that there are a number of ways in which inventory type information could be transmitted from tracks 24, 26, 28 to a central hub or information center 42. For example, track 28 is depicted as wirelessly communicating with information center 42. Information center 42 maintains inventory counts based on information from all the tracks 24, 26, 28 in the facility 12, and may calculate reordering thresholds or generate automatic reorder requests. As will be discussed below, these inventory calculations may alternatively be carried out by the tracks themselves.

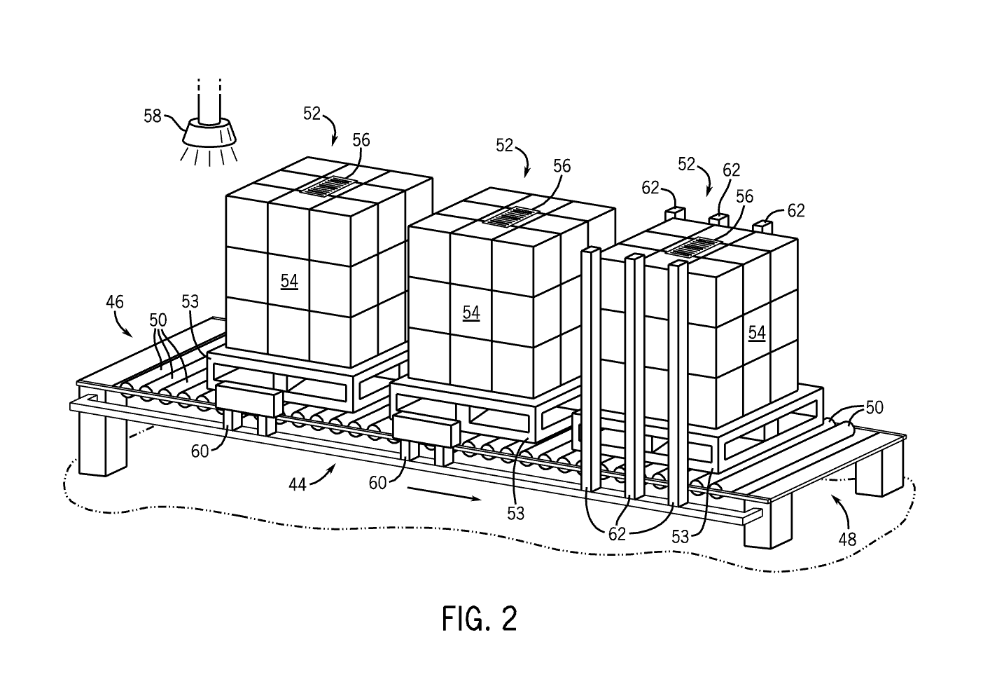

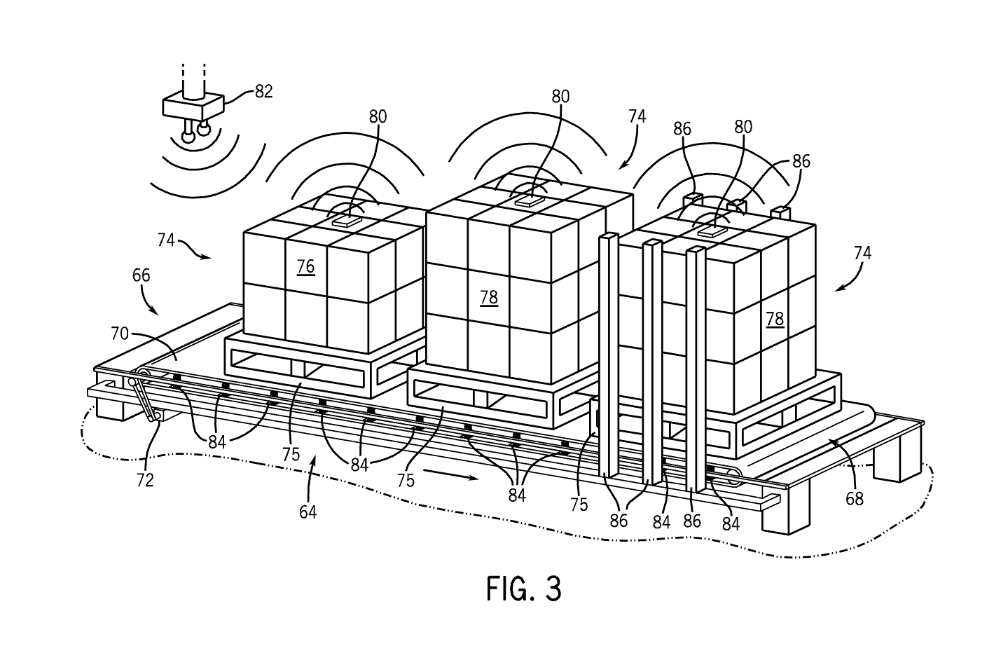

Referring now to FIG. 2, a detailed perspective view of an embodiment of the present invention shows its functionality in greater detail. It is appreciated that the length of track 44 may be considerably longer than what is depicted, and may conform to turns or curvature of the facility in which it is implemented. Regardless of the length or direction of a track 44, each has a first loading end 46 and a second unloading end 48. The loading end 46 of track 44 is shown slightly higher off the ground than the unloading end 48, so that inventory 52 will slide towards the unloading end 48 on rollers 50 due to gravity. Alternatively, the track may be powered to convey pallets 53, as will be described with reference to FIG. 3. Also, in the depicted embodiment, inventory units 52 are shown as pallets 53 having many smaller subunits or packages 54 loaded thereon.

With respect to the arrangements of sensors and detectors discussed previously, there are a number of sensor and detector types that may be used to acquire the same data or similar data to achieve the same purposes, as will be described below. Each inventory unit 52 is shown with a barcode label 56 affixed thereon so that a barcode reader 58 can scan each inventory unit 52 for identification and characteristic information. This information can include the type of consumable contained in the unit 52, the type of subunits or packages 54 in which the consumable is shipped, control numbers, serial numbers, lot numbers, vendor or manufacturer numbers, date codes, wire compositions, wire diameters, draw characteristics of wire, gas volumes or pressures, flux characteristics, temperature information, compatible welding equipment and accessories, appropriate or common uses of the inventory, and the like. The information may be transferred immediately to an information center 42, or may be recorded by a separate processing unit (not shown) of the track 44 itself. Alternatively, the reader 58 may have memory storage and processing capabilities, or the processing unit may be incorporated with the reader 58.

Track 44 also includes a series of horizontal counters or inventory unit sensors 60 which determine the presence of inventory 52 loaded on the track 44. Unit sensors 60 are used to maintain a count of how many inventory units 52 are on the track 44, to continuously monitor the positions of inventory units 52, and to determine when and which of the units 52 might be removed from the track 44 before reaching the unloading end 48. Unit sensors 60 are shown as optical or infrared sensors, which are disposed across from one another in pairs on opposite sides (not visible) of track 44 to detect the presence of units 52 by emitting a detection signal when an inventory object intervenes between the sensors 60. However, it is understood that other sensors may detect inventory units in varying ways, such as by measuring the weight on track 44 or by detecting when mechanical arms or levers are depressed as inventory units pass by on track 44. Thus, track 44 may manage an electronic queue of the inventory units 52 thereon by identifying the order in which the inventory units 52 are loaded onto the track, and which units 52 are removed from the track. Also, though unit sensors 60 are shown as spaced along the length of track 44, the function of unit sensors 60—to detect units 52—may also be achieved by a single sensor 60 which extends along the entire length of track 44.

Similarly, track 44 is displayed having end package detectors or subunit sensors 62. When a pallet reaches the unloading end 48 of track 44, packages are removed from pallets as needed for welding processes in the various cells of one or more work zones. However, to maintain a more accurate inventory count, it is often desirable for manufacturers to know not only how many inventory shipment units are on-hand, but also how many individual inventory packages or subunits remain on the shipment unit at the unloading end 48 of track 44. As shown, subunit sensors 62 may be optical or infrared sensors similar to unit sensors 60, though other sensor types are appreciated. Furthermore, it will be appreciated that the position, number, and orientation of sensors 62 may be varied depending upon the typical shipment unit type, shape, or other such constraints for better detection of which packages 54 are being removed, the approximate number of remaining packages 54, and other desired measurements.

In embodiments where all inventory units 52 are the same type (e.g. pallets) and only one type of consumable is loaded thereon, maintaining a queue of which inventory units 52 are located in which positions on track 44 is optional. Instead, a simple count of the number of inventory units 52 on track 44 could suffice for inventory monitoring purposes, especially in embodiments in which the track does not permit incorrect inventory types to be loaded thereon. Thus, if a unit was removed from the track before it reached the unloading end, efficient inventory management might only require knowing that the number of pallets was reduced rather than which particular pallet was removed, since the pallets are uniform. If a track permitted any type of inventory to be loaded thereon, and monitored which and where the wrong pallets were, then a queue may be desirable. In such an embodiment, each time a unit is loaded onto the track, a record might be made and stored in a queue, as will be further described below.

Referring now to FIG. 3, a perspective view of an alternative embodiment of that shown in FIG. 2 is displayed. Track 64 is shown having a loading end 66 and an unloading end 68. Both ends are the same distance off the ground, and thus movement of inventory 74 is accomplished via a track surface 70 turned by a track motor 72. The inventory 74 is again shown as shipped on pallets 75; however each pallet 75 is not loaded uniformly. That is, there are fewer packages 76 on one pallet 75 than there are packages 78 on the other two pallets 75. This illustration represents that the track 64 is adaptable to recognize either inventory of different consumable types 76, 78 or merely different amounts of the same inventory on shipment units 75. However, all inventory units 74 are shown having RFID tags 80 attached thereto. These are preferably passive RFID tags for lower per-unit costs, but may also be active RFID devices for increased range and reliability. In either event, RFID tags 80 are configured to transmit characteristic information regarding inventory units 74 to an RFID reader 82, such as done in the embodiment of FIG. 2 with bar code devices.

The track surface 70 is shown as supported by weight sensors 84. These may be compression transducers 84, suspension-type weight sensors, or other suitable means for measuring the weight of inventory 74. Regardless, weight sensors 84 function in one or both of two respects. First, weight sensors 84 may be used independently to determine the presence of an inventory unit 74 at particular positions along the length of track 64, and thus functioning in a similar manner to the horizontal unit detectors 60 of FIG. 2. In addition, weight sensors 84 may be used in combination to determine the total weight on the track surface 70 for an estimate of the amount of consumable inventory on the track. Finally, the embodiment shown in FIG. 3 includes package or subunit sensors 86 to monitor the level of packages remaining, as utilized in the embodiment of FIG. 2. Alternatively, manufacturers could simply provide operators with equipment for manually scanning packages as they are removed from the inventory unit 74 at the unloading end 68 of track 64, as another means for counting remaining packages.

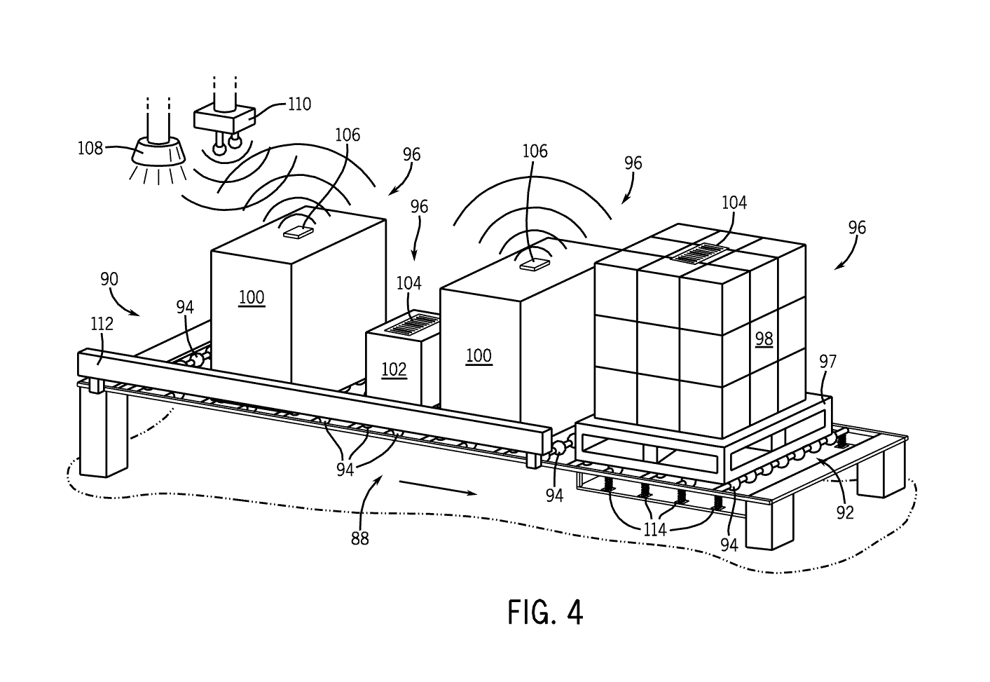

Referring now to FIG. 4, yet another embodiment of the present invention containing additional alternatives is shown in perspective view. Track 88 has a loading end 90 that is higher than its unloading end 92 so that inventory 96 slides along bearings 94 via gravity. Inventory 96 is shown as comprising different consumable types shipped on various types of inventory shipping units. The inventory unit at the unloading end 92 includes a pallet 97 having a number of packages 98 thereon. Additionally, large boxes 100 and small box 102 may also contain weld wire packages, other consumables, or accessories such as flux, electrode tips, shielding gas, or the like. Some of the inventory units 96 have bar codes 104 and some have RFID tags 106, from which characteristic information is read via bar code reader 108 and RFID reader 110 respectively.

As mentioned above, a single unit detector 112 may be employed to detect the presences and position of inventory objects on track 88. Unit detector 112 is shown as an optical or infrared sensor extending along the length of track 88, though other known methods for detecting the presence of inventory or other intervening objects may be employed. Finally, a weight sensor arrangement 114 is positioned under the unloading end only of track 88 to monitor the remaining consumable inventory subunits 98 per shipment unit 96. That is, the system is able to read the shipment weight and weight-per-subunit of each inventory unit 96 from the barcode or wireless information obtained from RFID reader or barcode scanner 108, and can then calculate the remaining subunits 98 of the last inventory unit 96 from the weight differential.

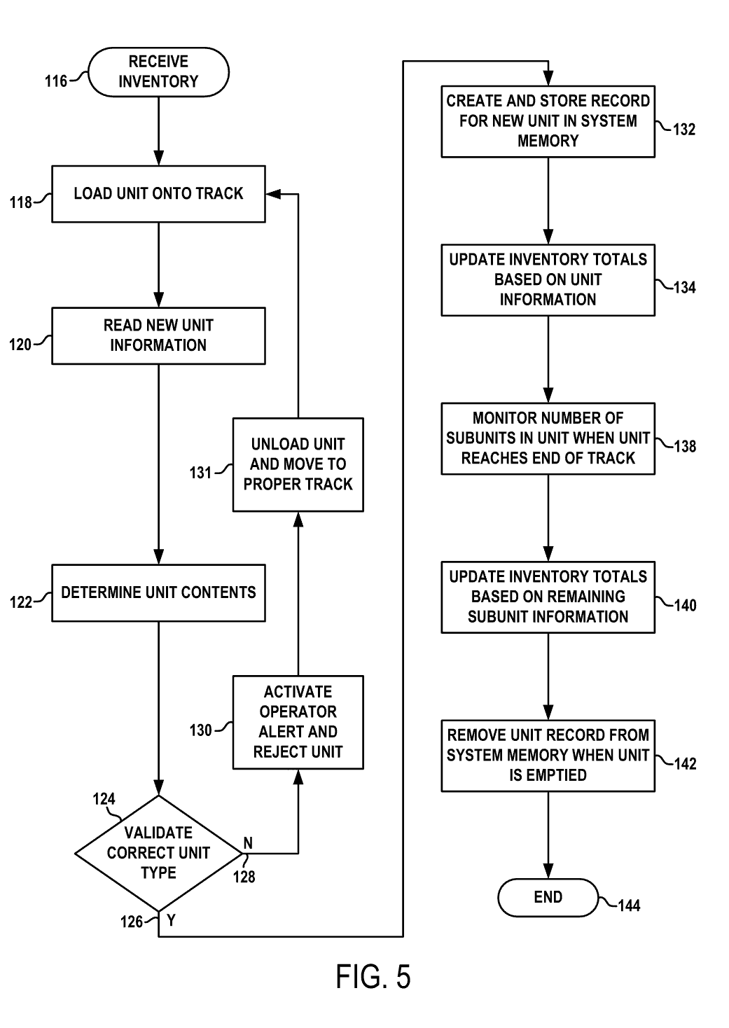

The manner in which systems of the present invention operate to process incoming inventory, determine current inventory amounts, calculate inventory reorder thresholds, determine the proper or improper location of particular shipment units, and other functionalities, will be described now with reference to FIGS. 5-7. All such determinations and calculations may be performed by processing units associated individually with a conveyor or by information centers or hubs which perform functions for all conveyors within a facility.

With reference to FIG. 5, processing of a new inventory shipment unit begins at 116 when the shipment unit arrives at a facility. The received shipment unit will be loaded onto an inventory track 118 for distribution to a work zone. Tracks may be located in or near the work zone or zones to which they supply inventory and/or may be labeled in a manner so that dock personnel can easily determine which types of inventory should be loaded on which tracks. The sensor and detector arrangements of the track help to further foolproof the loading process by reading data 120 from an RFID tag or barcode included with the inventory unit. From this data, the contents of the inventory unit are determined 122. Depending upon which types of information are available from the RFID tag or barcode, the procedure for determining shipment unit contents may vary. In systems where only one type of inventory is loaded on a track, determining the contents of each shipment unit could be as simple as reading quantity or count information or verifying that a preset code is present on the barcode or RFID tag of the unit. In systems where tracks are designated to receive multiple types of inventory, determining the contents of each shipment unit may involve such steps as reading and verifying several type codes, receiving data regarding the number of packages of each type within the unit, the size of each package, or the relative location of each type of inventory on the unit, or determining the weight of the unit. One skilled in the art will readily appreciate that the ability to read multiple types of data from various inventory units and determine the contents thereof enables the system to be compatible with multiple types of consumables and brands.

Once the contents of an inventory unit are known, the system validates 124 whether the inventory unit is the right type of inventory for the work zone or zones to which the track leads. The validation determinations may be carried out by an information center, a processing unit of the track, or by the data readers or scanners themselves. Regardless, an operator may designate or pre-select a number of inventory types which will be in use in a work zone to which the track leads. The designated welding inventory types are then stored as corresponding acceptable type codes in memory for comparison to the current unit's type code. Alternatively, the weight of a loaded unit may be measured against the known weight of inventory units corresponding to welding processes being carried out in a work zone to which the track leads, or other suitable means may be employed for validating the inventory type. If the inventory unit is not the correct type for any welding zone 128 which the track services, an alert or warning is indicated to the user and the unit is not conveyed to the zone or zones 130. Instead, the unit is removed from the track and brought to the proper track 131. In this regard, the tracks may include warning units including display messages, warning lights, or means for transmitting error codes or messages to operators. Once a warning is indicated, an operator then removes the inventory unit and loads it onto the appropriate track 118. If the inventory type is correct for the welding zone or zones to which the track leads 126, then the system creates and stores a data record in either an on-board track memory or in system memory containing the data read from the unit 132. The unit is considered to be processed at this point, and the facility's inventory totals stored in system memory are updated to reflect the contents of the inventory unit 134 via a communication means such as data lines or wireless transmissions, as discussed above.

Once an inventory unit has been conveyed to the unloading end of a track, welding personnel from the corresponding work zone or zones will begin to unload individual packages or subunits from the inventory unit for use in welding processes occurring in their cells. As the number of remaining subunits decreases, inventory subunit detectors apprise the system of the remaining subunits 138. If the inventory unit included more than one type of welding inventory, the system will use the relative location information for each type of inventory from the barcode or RFID scan in conjunction with the package or subunit scanner to determine which types of inventory are being removed. The system continuously or periodically updates inventory totals for the track and/or the entire facility to reflect this data 140. The sensors of the unloading end of the track may be configured to automatically trigger an inventory reevaluation when one or a specified number of subunits/packages are removed from the inventory unit at the unloading end of the track. Alternatively, the system may simply use a continuous monitoring to detect changes in the remaining inventory subunits at the unloading end of a track. By monitoring the removal of subunits or packages, the inventory totals for a facility will be more precise than if only inventory units or pallets were monitored. Yet, the inventory totals will also not be overly precise, as in the case of monitoring the linear feet of welding wire consumed at each welding process. Finally, when an inventory unit has been emptied, its record is deleted from the system memory 142. When a record is deleted, the system may take note of the time the unit was emptied, the time it took for the unit to be emptied, the day it was emptied, the processes and jobs being performed while it was being emptied, the time of year, etc., for purposes of calculating when new orders may be needed in the future.

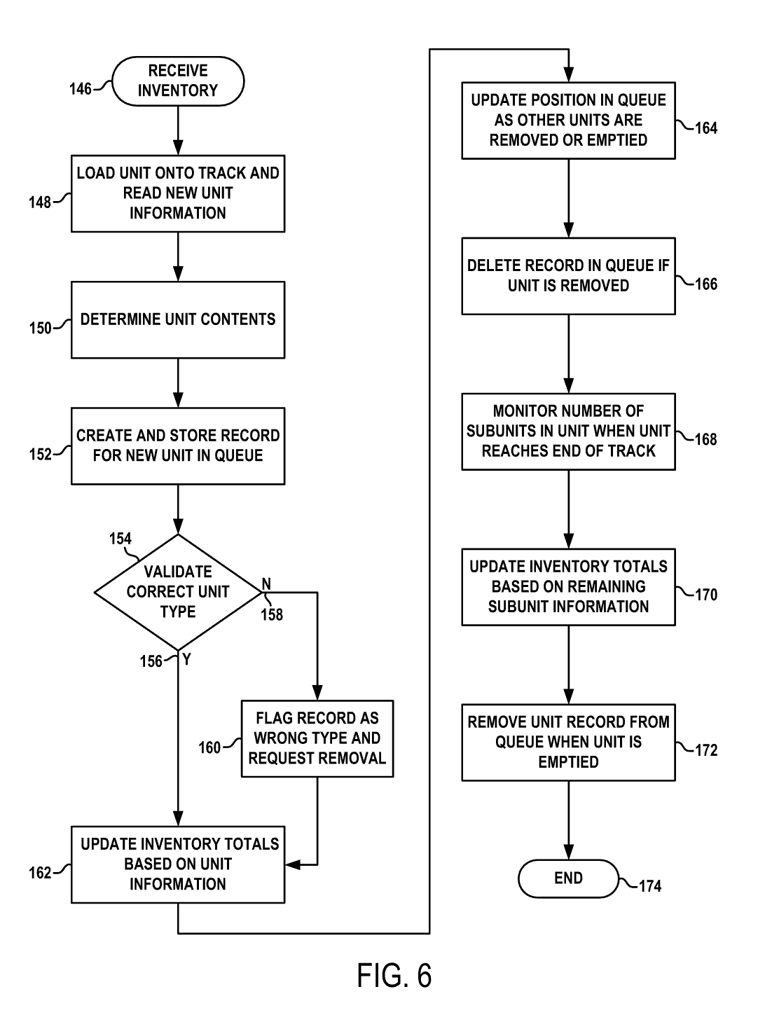

Referring now to FIG. 6, an alternative embodiment of the present invention is configured to permit inventory units to be loaded onto the wrong track in order to maintain the flow of inventory receiving. In such an embodiment, when an inventory unit is delivered 146, dock personnel load it onto a track 148 and the track reads or scans characteristic information therefrom. The system then determines the contents of the inventory unit 150. A record is created for the inventory unit having the unit's information, and is given a storage position within an electronic queue in the system memory 152. Thus, the system can monitor the position of the unit on the track regardless of whether it contains the proper consumable. When the system attempts to validate that the unit contains the correct inventory 154, the unit is already loaded onto the track and processed. The step of validating the unit's type may be performed as described above. In an alternate embodiment, the system may automatically determine which welding processes are being carried out in a work zone, and adjust which corresponding welding inventory may be accepted on the tracks accordingly. One of ordinary skill in the art will appreciate that many methods for automatically determining current welding processes are being performed, such as by wireless communication with welding equipment, user data entry or scans, and mapping of a facility's organization for particular production jobs. If the unit contains the wrong type of consumable inventory 158, the system flags the unit's record in the queue as “wrong type” and issues a removal request to the proper personnel 160. If the unit does contain the correct inventory type 156, then the system does not flag the unit's record. In either event, the system then updates the facility's inventory totals based on the contents of the unit 162.

While the unit is on the track, the system monitors its position in the queue relative to the other units on the track. The unit detectors 60, 84, or 112 of FIGS. 2, 3 and 4 respectively notify the track or system when and from which position on the track a unit is removed. In this manner, if a particular unit is removed from the track before it reaches the unloading end of the track and/or before its contents have been used up, the system can update the position of the remaining units 164 in memory. The records of the removed units are deleted from the queue and the positions of the remaining units on the track are updated 166. Thus, such an embodiment of the present invention always knows exactly where and which units are on each of the tracks continuously.

Once a unit reaches the unloading end of the track, subunit sensors monitor how many subunits remain on the unit 168 as welding personnel remove subunits for consumption in welding processes. As in the embodiment of FIG. 5, inventory totals for the facility are updated according to the subunit information 170, and unit records are deleted when the units are emptied 172, at which time the system no longer processes inventory of the unit 174.

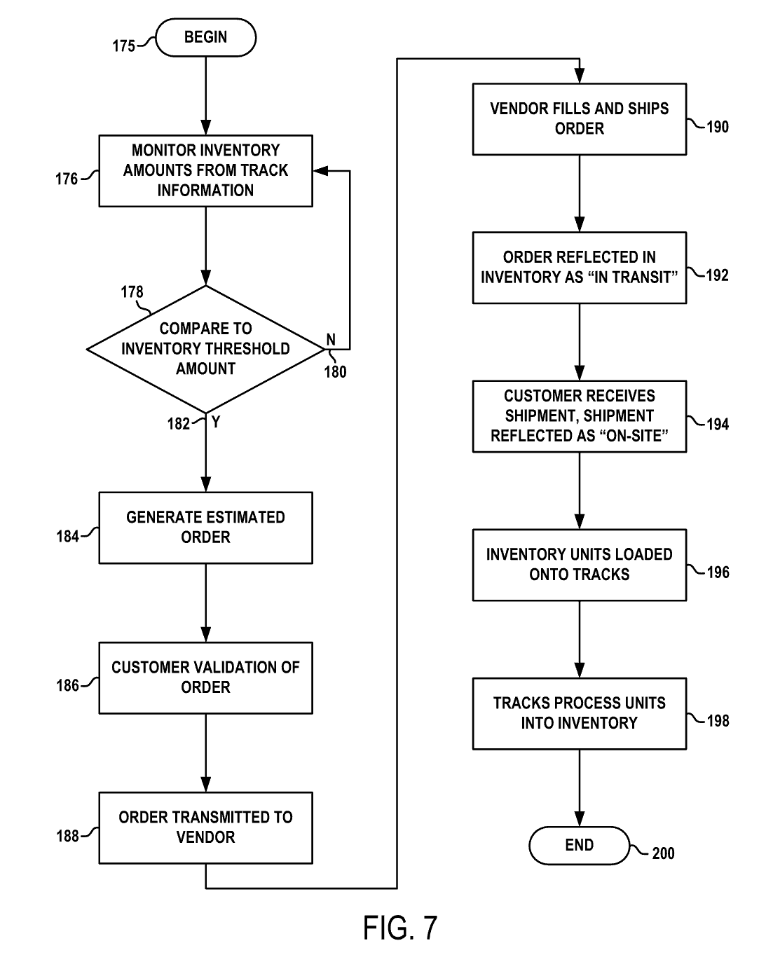

Referring now to FIG. 7, a flow chart for a high level inventory maintenance process of one embodiment of the present invention is shown. Upon initialization, the system begins 175 by maintaining a constant inventory count 176 based upon the inventory information received from each track. The inventory counts for all inventory types are updated when new inventory shipment units are processed, when packages or subunits are removed from units being unloaded on tracks, and when units are emptied or otherwise removed from the facility. The system may also be configured to refresh the inventory counts for some or all inventory types at preset, periodic intervals.

The manner in which the system determines whether a reorder is needed 178 will vary on a case by case basis according to each facility's needs, consumption rates, budgets, receiving and storage capabilities, and other factors. While the description herein of one embodiment of a reordering procedure contains several steps and takes multiple variables into account, it is appreciated that many of these steps and considerations are optional or that others may be necessary. In each embodiment, however, the system will utilize current inventory counts maintained in memory for each type of inventory. In addition, some systems may take into account shipments in transit and/or shipping units on-hand which have not yet been processed by the tracks when determining whether additional orders are required.

In one version of the present invention, manufacturers may simply pre-set minimum levels of inventory they wish to maintain on-hand for each type of inventory. When the inventory counts reach this threshold level, the system may either issue an automated order request to the inventory vendor, or may simply notify operators at the facility that more inventory must be ordered. Alternatively, the system may calculate actual or average rates of use for each type of inventory from the date and time information recorded by the tracks as inventory units are used up. Usage rates may also be broken down statistically to depend upon additional variables, such as which types of jobs were being performed when usage rates were high or low, to adjust for fluctuations in consumable demand. Records of the amount of time it has taken vendors to fill and ship orders may also be kept for purposes of order calculation. Thus, the system can calculate threshold reorder values as both inventory amounts and as dates, based upon the current inventory counts and a prediction of the rate at which the inventory will be used.

The comparison of the inventory counts to a present minimum or the calculation of other threshold statistics may occur continuously, or be set for periodic checks, such as daily or weekly. If the system determines that an order is not needed 180, the system will revert to monitoring inventory totals. If the system determines that an order is needed 182, the process of generating an estimated order begins 184. Manufacturers may input storage limitations of the facility and/or warehouses or other desired maximum inventory amounts to serve as a benchmark for inventory order quantities. Otherwise, the system may simply order enough new inventory shipment units to fill the tracks that are near empty or emptying. As shown, the system then submits an estimated order to the manufacturer for approval 186.

In other embodiments, manufacturers may generate their own order estimates manually or by other internal means. In a preferred embodiment, the system reports the inventory information, the threshold value comparisons, or both directly to the appropriate vendor or vendors automatically via an external communication means. In such an automated embodiment, the manufacturer will essentially never have to reorder inventory or materials, yet will also never run out of a required type of inventory. In all embodiments, however, an order is received by a vendor 188 who fills and ships the requested amounts of inventory 190. Preferably, vendors will communicate a notice to the manufacturer or directly to the system when the full order or a partial order has been shipped, so that the system may reflect such inventory as “in transit” 192 for subsequent ordering calculations to avoid duplicative orders. Similarly, when the manufacturer receives the ordered shipment units, they may be temporarily reflected in the system as “on-site” 194 before they are loaded onto the appropriate tracks 196 and processed into inventory counts 198. The processing of inventory units may be done in any of the variations of inventory processing methods discussed with reference to FIG. 5 or 6.

Accordingly, it has been shown that the present invention provides a flexible and adaptable wireless communication system for welding-type devices. The present invention is particularly useful in locating and maintaining an inventory of welding-type devices, in preventing theft and misplacement of devices, and in organizing maintenance and resource distribution.

Therefore, an inventory management system is provided having a conveyor which is configured to move and store inventory units of welding-type consumables or other materials to at least one work zone. A reader is positioned at the first end of the conveyor to determine type information from welding inventory units as they are loaded onto the conveyor. An inventory unit sensor is arranged to detect the presence of inventory units on the conveyor and an inventory subunit sensor is positioned at the second end of the conveyor to detect the number of inventory subunits remaining on an inventory unit. Data from the reader, the inventory unit sensor, and the inventory subunit sensor is received by an information center. The reader, the inventory unit sensor, or both determine whether the welding inventory units loaded onto the conveyor correspond to welding processes being performed in the at least one work zone.

The present invention also includes an apparatus for maintaining welding consumable inventory which includes at least one storage surface having a loading end in a receiving area and an unloading end in a work zone. The loading end is configured to receive and scan information from welding consumable shipment units and the unloading end is configured to detect the number of remaining subunits of a welding consumable shipment unit. A processing unit is also included that is configured to determine whether the welding consumable shipment units on a storage surface are of the correct type to be used in the work zone, to manage a queue of the welding consumable shipment units on a storage surface, and to calculate at least one inventory amount thereof.

A method for implementing an automated welding inventory system is also provided. The method includes delivering welding consumable bulk shipments to a welding facility, monitoring type information for each bulk shipment loaded onto a conveyor, and monitoring the quantity of each bulk shipment type. Current inventory counts are then maintained for each type of welding consumable received, based on the shipment type information and quantity received. When one or more of the inventory counts is reduced to a threshold amount, an order request is generated for additional welding consumable shipments, which are then delivered to the facility.

The present invention has been described in terms of the preferred embodiment, and it is recognized that equivalents, alternatives, and modifications, aside from those expressly stated, are possible and within the scope of the appending claims.

1. An inventory management system comprising:
a conveyor configured to store and move welding inventory units to at least one work zone;
a reader positioned at a first end of the conveyor to read type information of each welding inventory unit loaded onto the conveyor;
an inventory unit sensor arranged to detect welding inventory units on the conveyor;
an inventory subunit sensor positioned at a second end of the conveyor to detect a number of welding inventory subunits within a welding inventory unit;
an information center connected to receive data from the reader, the inventory unit sensor, and the inventory subunit sensor; and
wherein one of the reader and the information center is programmed to determine whether each welding inventory unit loaded onto the conveyor corresponds to a welding process being performed in the at least one work zone.

2. The inventory management system of claim 1 wherein the inventory unit sensor and the inventory subunit sensor each comprise at least one of a weight sensor, an optical sensor, and a mechanical sensor.

3. The inventory management system of claim 1 wherein the type information is stored on welding inventory units and the reader is positioned to read the type information wirelessly therefrom.

4. The inventory management system of claim 1 wherein welding inventory units corresponding to welding processes of the work zone are one of predetermined by a user or automatically selected.

5. The inventory management system of claim 4 further comprising a warning unit to alert operators when a welding inventory unit not corresponding to a welding process of the at least one work zone is loaded on the conveyor.

6. The inventory management system of claim 1 wherein the information center is configured to monitor an inventory count for welding consumable inventory types from the received data.

7. The inventory management system of claim 6 wherein the information center is further configured to generate a reorder request when the inventory count reaches a threshold value.

8. An apparatus for maintaining welding consumable inventory comprising:
at least one storage surface having a loading end in a receiving area and an unloading end in a work zone;
the loading end configured to receive welding consumable shipment units and scan information therefrom;
the unloading end configured to detect a remaining number of subunits of a welding consumable shipment unit; and
at least one processing unit configured to:
determine whether welding consumable shipment units loaded onto the at least one storage surface are of a type to be used in the work zone;
manage a queue of welding consumable shipment units loaded onto the at least one storage surface; and
calculate at least one inventory amount thereof.

9. The apparatus of claim 8 wherein the at least one storage surface is configured for unloading in a single-file order.

10. The apparatus of claim 8 wherein the at least one processing unit is further configured to generate a replenish order when the at least one inventory amount is reduced to a threshold value.

11. The apparatus of claim 8 further comprising a detector positioned between the loading end and the unloading end to monitor welding consumable shipment units on the at least one storage surface.

12. The apparatus of claim 8 wherein the loading end of the at least one storage surface further comprises a shipment unit sensor and the unloading end of the at least one storage surface further comprises a shipment subunit sensor.

13. The apparatus of claim 8 wherein the loading end of the at least one storage surface is further configured to alert an operator when a welding consumable shipment unit is loaded thereon, which is not of a type to be used in the work zone.

14. A method for implementing an automated welding inventory system comprising the steps of:
delivering at least a first type and a second type of welding consumable bulk shipments to a welding facility;
loading the first type of wielding consumable bulk shipment onto a first conveyor, and loading the second type of welding consumable bulk shipment onto a second conveyor;
monitoring a quantity of each bulk shipment type on the respective conveyor;
maintaining at least one current inventory count by type of welding consumable, based upon the quantity and type of bulk shipments monitored;
generating an order request for additional welding consumable bulk shipments when the at least one inventory count reaches a threshold amount; and
delivering a new shipment of welding consumable bulk shipments.

15. The method of claim 14 further comprising the step of outfitting at least one conveyor to convey bulk shipments in a first-in, first-out order.

16. The method of claim 14 wherein the step of monitoring bulk shipment quantity further includes at least one of receiving characteristic information for each bulk shipment, monitoring a number and position of bulk shipments on a conveyor, or monitoring a number of remaining packages of a bulk shipment.

17. The method of claim 14 further comprising the step of causing only one type of bulk shipment to be loaded onto a conveyor.

18. The method of claim 17 further comprising at least one of configuring the conveyor to reject bulk shipments of an incorrect type or causing a removal request to be issued for bulk shipments of an incorrect type.

19. The method of claim 15 further comprising calculating the inventory threshold amount in consideration of a rate of use of at least one inventory type.

20. The method of claim 15 further comprising causing the at least one current inventory count to be automatically transmitted to an inventory vendor.

21. An inventory monitoring system comprising:
at least one inventory storage track having first and second ends;
an identification scanner positioned at the first end of the at least one inventory storage track and configured to scan identifying information from welding inventory units loaded onto the at least one inventory storage track;
an inventory unit detector positioned between the first and second ends of the at least one inventory storage track and configured to detect a number and a relative position of welding inventory units on the at least one inventory storage track; and
a processor connected to receive data from the identification scanner and the inventory unit detector and programmed to continuously monitor a location of each welding inventory unit therefrom.
